(19) United States
(12) Patent Application Publication
(10) Pub. No.: US 2020/0066474 A1
(43) Pub. Date: Feb. 27, 2020

(54) CATHODES WITH CONFORMAL CATHODE SURFACES, VACUUM ELECTRONIC DEVICES WITH CATHODES WITH CONFORMAL CATHODE SURFACES, AND METHODS OF MANUFACTURING THE SAME

(71) Applicant: Modern Electron, LLC, Bothell, WA (US)

(72) Inventors: John J. Lorr, Redmond, WA (US); Daniel Kraemer, Kirkland, WA (US); Dusan Coso, Redmond, WA (US); Max N. Mankin, Seattle, WA (US); Tony S. Pan, Bellevue, WA (US); Ad de Pijper, Redmond, WA (US)

(73) Assignee: Modern Electron, LLC, Bothell, WA (US)

(21) Appl. No.: 16/430,431

(22) Filed: Jun. 4, 2019

Related U.S. Application Data
(60) Provisional application No. 62/721,343, filed on Aug. 22, 2018.

(51) Int. Cl. H01J 1/146; H01J 9/04; H01J 9/18

(52) U.S. Cl. CPC H01J 1/146; H01J 2201/28; H01J 9/18; H01J 9/042

(57) ABSTRACT

Disclosed embodiments include cathodes with conformal cathode surfaces, vacuum electronic devices with cathodes with conformal cathode surfaces, and methods of manufacturing the same. In a non-limiting embodiment, a cathode for a vacuum electronic device includes: a substrate having a predetermined shape; and electron emissive material disposed on at least one portion of at least one surface of the substrate, a shape of the electron emissive material conforming to the predetermined shape of the substrate.

### RELATED APPLICATION

The present application claims the benefit of priority of filing from U.S. Provisional Patent Application Ser. No. 62/721,343, filed Aug. 22, 2018, and entitled “Cathodes for Thermionic Electrodes in Vacuum Electronics Having Conformal Cathode Surfaces And Methods Of Manufacturing The Same,” the entire contents of which are incorporated by reference.

### TECHNICAL FIELD

The present disclosure relates to cathodes for vacuum electronic devices.

### BACKGROUND

Thermionic vacuum electronic devices include vacuum tubes, electric thrusters, gyrotrons, klystrons, travelling wave tubes, thermionic converters, and the like. These devices all rely upon an electron source, which is typically a heated thermionic cathode that thermally emits electrons.

An example of a thermionic cathode is a dispenser cathode. Dispenser cathodes may include a porous construct of tungsten or molybdenum or other metal. These cathodes generally are fabricated before electron-emissive materials are introduced into the construct's pores. Typical formulations of emissive material include various ratios of barium oxide, calcium oxide, and aluminum or strontium oxide. Additional materials such as scandium oxide may also be introduced into the cathode at various stages of the cathode's construction to improve the emission characteristics of the cathode.

Manufacture of cathode surfaces that are properly matched to the geometries of these devices may be difficult and may frequently entail a compromising of the cathode form in a manner that may not be desirable or ideal to the efficient functioning of the device. For example, the spraying method for depositing carbonate on certain classes of thermionic cathodes may result in particle agglomeration, density variation, and high surface roughness of the electron emissive layer. The resulting emission characteristics of the cathode can be detrimentally impacted (such as by non-uniform emission, pitting, and the like), and detrimental agglomeration of particles can result during a defective spray operation. This generally results in variable and undesirable surface roughness and density of the spray coat. Taken together with voids, these factors may create a “patchy” emission effect where areas of the cathode are dissimilar enough that the entire cathode presents as an amalgam of smaller cathodes with different emission characteristics that will broaden and blur the anticipated performance characteristics of the cathode.

Moreover, large-area thermionic cathodes are very expensive. For instance, a 1-inch diameter barium dispenser cathode may cost tens of thousands of dollars.

### SUMMARY

Disclosed embodiments include cathodes with conformal cathode surfaces, vacuum electronic devices with cathodes with conformal cathode surfaces, and methods of manufacturing the same.

In a non-limiting embodiment, a cathode for a vacuum electronic device includes: a substrate having a predetermined shape; and electron emissive material disposed on at least one portion of at least one surface of the substrate, a shape of the electron emissive material conforming to the predetermined shape of the substrate.

In another non-limiting embodiment, a thermionic vacuum electronic device includes: a cathode including: a substrate having a predetermined shape; and electron emissive material disposed on at least one portion of at least one surface of the substrate, a shape of the electron emissive material conforming to the predetermined shape of the substrate; an anode spaced apart from the cathode; and a heat source thermally couplable to the substrate.

In another non-limiting embodiment, a method of fabricating a cathode for a vacuum electronic device includes: providing a substrate having a predetermined shape; and conformally disposing electron emissive material on at least one portion of at least one surface of the substrate such that a shape of the electron emissive material conforms to the predetermined shape of the substrate.

In another non-limiting embodiment, a method of fabricating a thermionic vacuum electronic device includes: defining a cathode, wherein defining the cathode includes: providing a substrate having a predetermined shape; and conformally disposing electron emissive material on at least one portion of at least one surface of the substrate, a shape of the electron emissive material conforming to the predetermined shape of the substrate; defining an anode that is spaced apart from the cathode; and disposing a heat source proximate the substrate such that the heat source is thermally couplable to the substrate.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the text (e.g., claims and/or detailed description) and/or drawings of the present disclosure.

### BRIEF DESCRIPTION OF THE FIGURES

Illustrative embodiments are illustrated in referenced figures of the drawings. It is intended that the embodiments and figures disclosed herein are to be considered illustrative rather than restrictive.

FIG. 1A is a cutaway side plan view in partial schematic form of an illustrative cathode.

FIG. 1B is a cutaway side plan view in partial schematic form of another illustrative cathode.

FIG. 1C is a cutaway side plan view in partial schematic form of another illustrative cathode.

FIG. 1D is a cutaway perspective view in partial schematic form of another illustrative cathode.

FIG. 1E is a cutaway side plan view in partial schematic form of another illustrative cathode.

FIG. 1F is a cutaway perspective view in partial schematic form of the cathode of FIG. 1E.

FIG. 1G is a cutaway side plan view in partial schematic form of another illustrative cathode.

FIG. 1H is a cutaway side plan view in partial schematic form of another illustrative cathode.

FIG. 1I is a cutaway side plan view in partial schematic form of another illustrative cathode.

FIG. 1J is a cutaway side plan view in partial schematic form of another illustrative cathode.

FIGS. 1K and 1L are top plan views in partial schematic form of illustrative cathodes having patterned electron emissive layers.

FIG. 2A is a cutaway side plan view in partial schematic form of another illustrative cathode.

FIG. 2B is a cutaway side plan view in partial schematic form of another illustrative cathode.

FIG. 2C is a cutaway side plan view in partial schematic form of another illustrative cathode.

FIG. 3A is a cutaway side plan view in partial schematic form of an illustrative thermionic vacuum electronic device.

FIG. 3B is a cutaway side plan view in partial schematic form of another illustrative thermionic vacuum electronic device.

FIG. 3C is a cutaway side plan view in partial schematic form of another illustrative thermionic vacuum electronic device.

FIGS. 4A-4E illustrate fabrication of an illustrative cathode.

FIGS. 4F-4J illustrate fabrication of another illustrative cathode.

FIGS. 4K-4M illustrate fabrication of another illustrative cathode.

FIG. 5A is a cutaway side plan view in partial schematic form of details of the illustrative thermionic vacuum electronic device of FIG. 3A.

FIG. 5B is a cutaway side plan view in partial schematic form of details of the illustrative thermionic vacuum electronic device of FIG. 3C.

### DETAILED DESCRIPTION

In the following detailed description, reference is made to the accompanying drawings, which form a part hereof. In the drawings, the use of the same symbols in different drawings typically indicates similar or identical items unless context dictates otherwise. The illustrative embodiments described in the detailed description, drawings, and claims are not meant to be limiting. Other embodiments may be utilized, and other changes may be made, without departing from the spirit or scope of the subject matter presented here.

### Overview

Given by way of non-limiting overview, Disclosed embodiments include cathodes with conformal cathode surfaces, vacuum electronic devices with cathodes with conformal cathode surfaces, and methods of manufacturing the same. As will be explained below, in various embodiments illustrative cathodes may conform to a surface of a substrate. As will also be explained below, various illustrative disclosed fabrication techniques may help permit use of various methods of application on substrate surfaces, and/or may help permit large surfaces to be used as cathodes, and/or may help contribute to improving manufacturability of cathodes for complex geometries.

### Illustrative Examples of Cathodes and Vacuum Electronic Devices

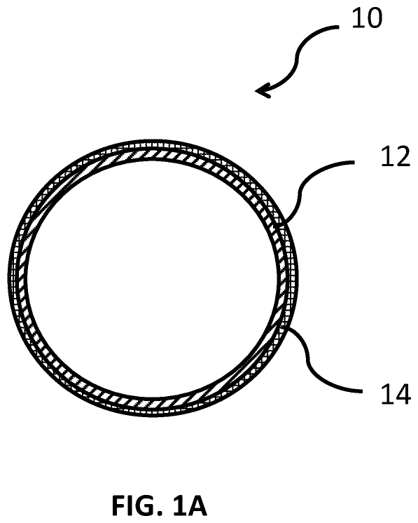

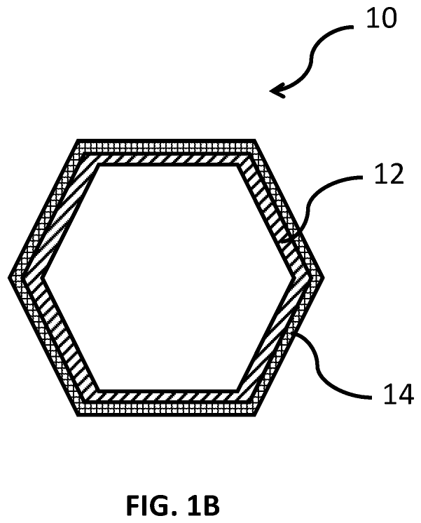

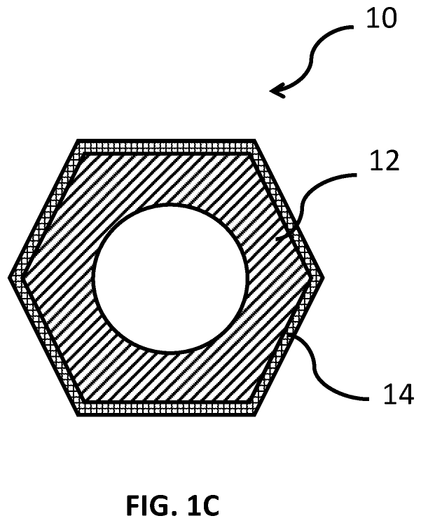

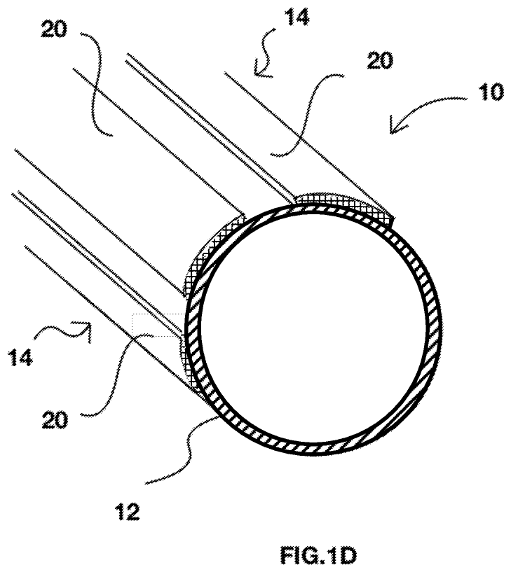

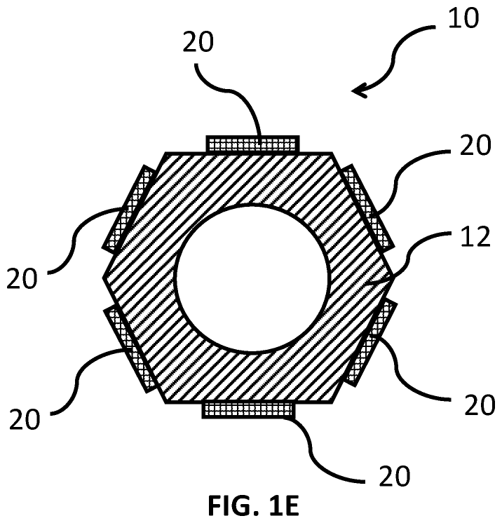

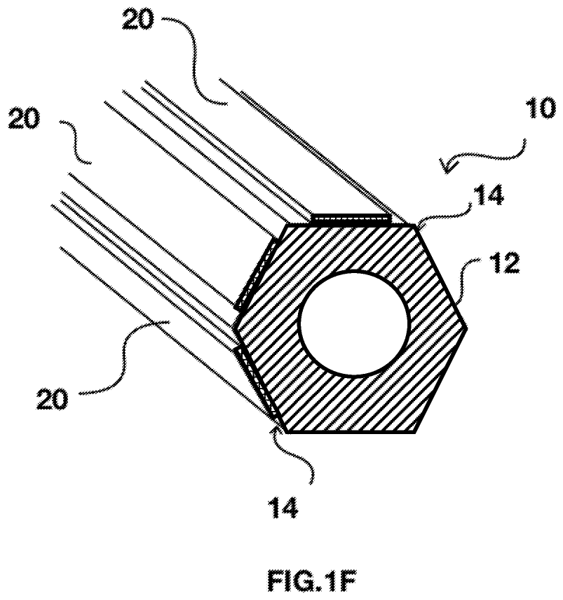

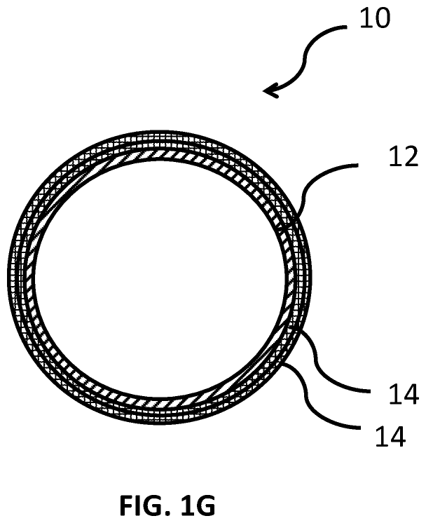

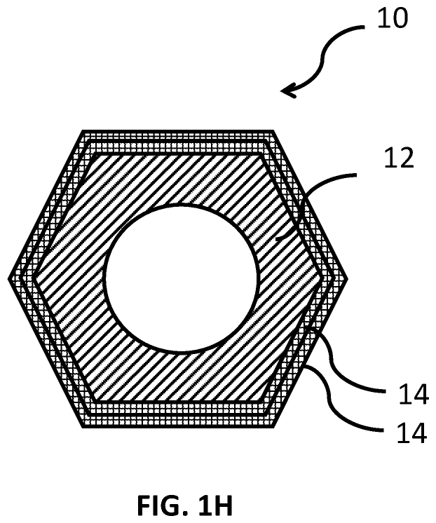

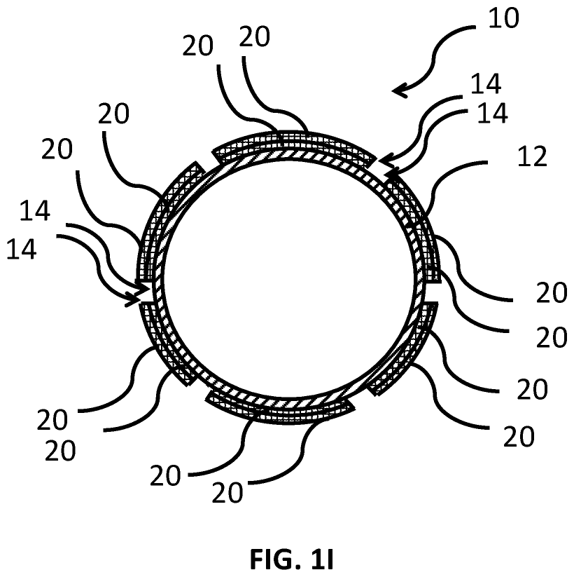

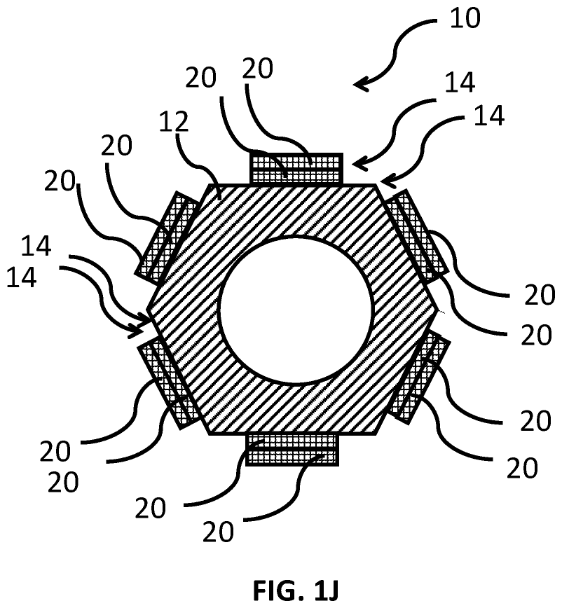

Referring to FIG. 1, in various non-limiting embodiments an illustrative cathode 10 is provided for a vacuum electronic device (not shown). The cathode 10 includes a substrate 12. The substrate 12 suitably has a predetermined shape. The cathode 10 also includes electron emissive material 14 that is disposed on at least one portion of at least one surface of the substrate 12. A shape of the electron emissive material 14 conforms to the predetermined shape of the substrate 12.

It will be appreciated that, in various embodiments, any portion of an electrically insulated surface of the substrate 12 without the electron emissive material 14 disposed thereon electrically isolates the electron emissive material 14. As will be shown below, such electrical isolation isolates the cathode 10 from other electrodes (not shown) of the vacuum electronic device (not shown).

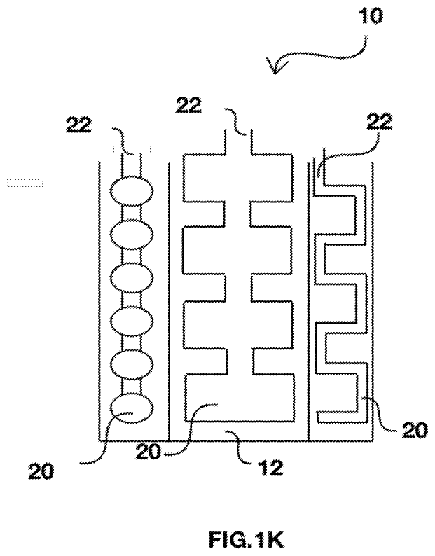

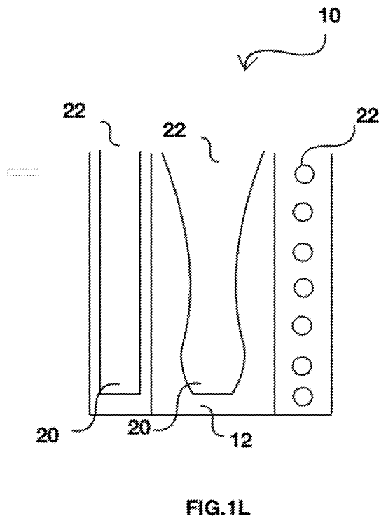

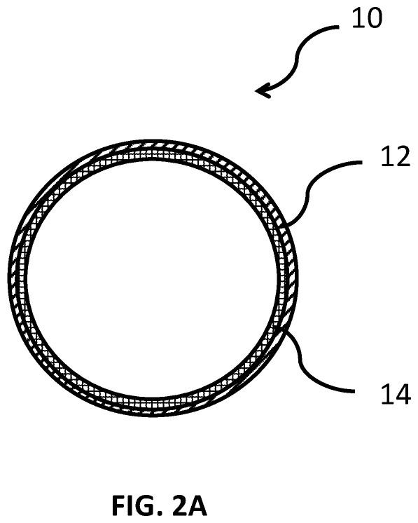

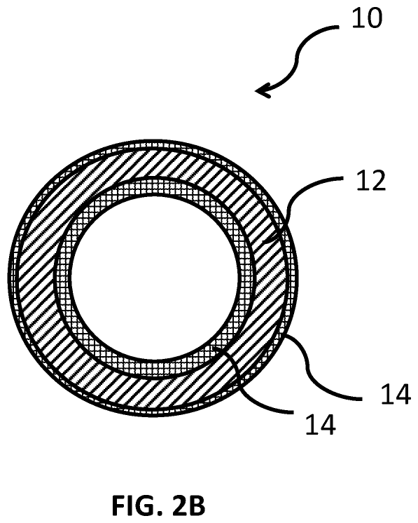

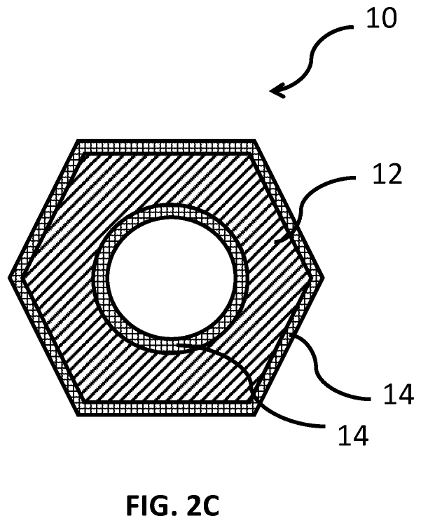

Referring additionally to FIGS. 1B-1J, 2A-2C, and 3, it will be appreciated that the shape of the substrate 12 as shown in FIG. 1 is shown by way of illustration only and not of limitation. To that end, in various embodiments the substrate 12 may have any shape as desired for a particular application. Given by way of non-limiting examples, in various embodiments the substrate 12 may have a shape such as a cylinder (FIGS. 1A, 1D, 1G, 11, 2A, 2B, and 3), a polygonal cylinder (FIGS. 1B, 1C, 1E, 1F, 1H, 1J, and 2C), a polyhedron, a tube (FIGS. 1A, 1D, 1G, 11, 2A, 2B, and 3), a plane, a sheet, a slab, or the like. Again, it is emphasized that the substrate 12 may have any shape as desired for a particular application, that no limitation regarding shape of the substrate 12 is intended, and that no limitation regarding shape of the substrate 12 is to be inferred.

While the substrate 12 is shown in FIGS. 1B, 1C, 1E, 1F, 1H, 1J, and 2C as having a hexagonal shape, no such limitation is intended and is not be inferred. For example and given by way of illustration and not of limitation, in various embodiments the substrate 12 may have any number of facets as desired for a particular application.

As a result of the variety of possible shapes for the substrate 12, the cathode 10 and vacuum electronics devices that include the cathode 10 may have arbitrary forms as desired for a particular application. For example, it will be appreciated that a polygonal-cylinder geometry helps enable flat cathode surfaces to be placed opposite flat collector surfaces in thermionic vacuum electronic devices.

As another example, curved cathodes 10 can be useful to help contribute to optimizing electron optics in some vacuum electronic devices (such as without limitation ion thrusters, tube amplifiers, klystrons, travelling wave tubes, inductive output tubes, and the like). Such optimization can help provide an opportunity to form curved or alternatively-shaped cathodes that: (a) may be outside the capability of traditional cathode machining; (b) may be better suited to help contribute to optimizing electron emission geometries for more optimized electron optics; (c) rely on shaping ceramic instead of metal composite; and/or (d) can be formed into arbitrary shapes.

In various embodiments, the substrate 12 suitably is made of a material that is a good conductor of heat, that is sufficiently resistant to heat damage, and can provide mechanical support. Thus, in such embodiments the substrate 12 can help protect the electron emissive layer 14 from oxidizing environments and can help provide mechanical support to the electron emissive layer 14. In such cases, the heat source in a thermionic vacuum electronics device that includes embodiments of the cathode 10 is physically separated from the cathode 10.

However, some applications that do not involve such high temperatures. In such embodiments, it will be appreciated that the substrate 12 need not include high thermal conductivity characteristics.

In some embodiments, if desired, the cathode 10 optionally may be separated from the heat source hermetically. That is, in such instances the cathode 10 is not exposed to the same atmosphere as the heat source. For example, in the case of combustion for a thermionic converter, the cathode 10 may be less likely to corrode because the material of the substrate 12 is corrosion-resistant and is compatible with the combustion environment.

In various embodiments, the substrate 12 (or, in some instances, the sides of the substrate 12 or a portion of the substrate 12) may be made of and/or coated with an electrically insulating material. It will be appreciated that, in such embodiments, the electrically insulating material may be any electrically insulating material as desired for a particular application.

In some such embodiments and given by way of non-limiting example, the substrate 12 may be made of one or more ceramic materials such as, without limitation, aluminum oxide, silicon carbide, zirconium oxide, silicon oxide, silicon nitride, and/or a combination thereof. It will be appreciated that ceramic material suitably is used for the substrate 12 in some embodiments because ceramic material is corrosion and oxidation resistant and is compatible with a combustion environment (such as that which may be entailed in thermionic vacuum electronic devices). Resistance to oxidation may also be advantageous in non-combustion heating scenarios. For instance, use of molybdenum disilicide heating elements in air could provide sufficient heat for a thermionic emitter without relying on combustion.

In some other embodiments and given by way of other non-limiting examples, the substrate 12 may be made of one or more metals, a multi-layer ceramic/refractory structure allowing electron transport within the multilayer substrate structure, and/or a ceramic-to-metal graded structure. For example, in some embodiments, if desired the substrate 12 may be made from a metal coated on at least one surface with an electrically insulating material. In such embodiments, illustrative metals may include without limitation stainless steel, copper, molybdenum, titanium, and high temperature alloys. In such embodiments, illustrative insulating materials may include without limitation high temperature ceramics, silicon carbide, silicon nitride, alumina, and other non electically conductive high temperature ceramics. It will be appreciated that such embodiments may provide advantages in terms of stresses.

In various embodiments the electron emissive material 14 may include one or more metals such as, without limitation, tungsten, molybdenum, manganese, titanium, osmium, platinum, nickel, tantalum, rhenium, niobium, and/or a combination thereof. The metal may have any grain size as desired. It will be appreciated that inclusion of such metals in the electron emissive material 14 provides the electrons that are emitted from the electron emissive material 14 when heated.

In various embodiments the electron emissive material 14 may also include one or more electron emission enhancing materials such as, without limitation, barium, calcium, thorium, strontium, barium oxide, calcium oxide, thorium oxide, strontium oxide, scandium oxide, vanadium oxide, lanthanum, lanthanum oxide, molybdenum oxide, cesium, cesium oxide, tungsten oxide, a boride of lanthanum, cerium, cerium oxide, a boride of cerium, scandium, vanadium, carbon, and/or a combination thereof. In some such embodiments, it may be possible to include certain electron emission enhancing components, such as for example thorium oxide, prior to sintering of the cathode structure (discussed below). It will be appreciated that some electron emission enhancing materials, such as for example thorium oxide, may be able to withstand conditions entailed in sintering the cathode without being converted into less desirable compounds and may be able to tolerate longer term exposure to air that would accompany the total manufacturing process time without deteriorating due to exposure to less-controlled conditions or uncontrolled conditions, such as forming hydroxides from humidity in the air, and becoming inert. It will also be appreciated that some other electron emission enhancing materials may be added post-sintering.

In various embodiments, the electron emissive material 14 may be created from a metal slurry that is deposited on the substrate 12. In various embodiments the metal slurry may be embodied as a semiliquid mixture of particles suspended in a fluid. In various embodiments the applied slurry may have a thickness in a range from around one micrometer to around one (or more) millimeter(s).

In some such embodiments, the metal slurry can include metal particles, oxide/ceramic particles, a binder, and a solvent/dispersant. The solvent/dispersant helps keep metal and oxide particles dispersed. The binder helps the freshly-deposited metal slurry to adhere to the substrate 12 as a continuous film. The solvent/dispersant and the binder are boiled/burned off before the firing/sintering process. During the firing/sintering process, oxidized metal particles (such as manganese oxide, titanium oxide, tungsten oxide, molybdenum oxide, cesium oxide, and the like) diffuse into the substrate 12 to form a strong bond between the metallization (that is, the electron emissive material 14) and the substrate 12. In various embodiments the binder may include nitrocellulose, ethyl cellulose, and damar. In some embodiments, the slurry may include other inclusions. For example, barium or scandium compounds may be included to beneficially modify the electron emission properties of the cathode material.

In some such embodiments, the metal slurry may contain particles of arbitrary size (such as, for example, less than 1 micron, less than 5 microns, less than 10 microns, less than 100 microns, and the like). It will be appreciated that sintered properties of the processed electron emissive material 14 can be altered by, among other things, varying the particle size of the slurry. It will be appreciated that a smaller particle size can help favor higher post-sintering density. If the cathode material is intended as a matrix for an impregnated dispenser style cathode, then the porosity of the matrix will be of importance and can be controlled in part by the pre-sintered particle size of the metal slurry. Given by way of non-limiting example, tungsten or molybdenum particles form the matrix that provides the porosity into which smaller, high-electron-emitting particles (such as barium) fit in making a dispenser cathode. The inclusions can also be varied to desired particle size as, for example, the benefit of scandium oxide on cathode emission performance is tied to particle size, in that case being tens of nanometers in diameter.

As shown in FIGS. 1D, 1E, 1F, 1I, and 1J, in some embodiments the electron emissive material 14 may include segments 20 that are electrically insulated from each other. As a result, areas of the cathode 10 may be wired in series or in parallel as desired for a particular application by electrically isolating the segments 20 from each other while still using the same heat source (not shown). Also, electrically isolating the segments 20 from each other can help to promote uniform cathode heating given all cathodes are mounted on the same substrate 12 (as opposed to having isolated cathodes with differing temperatures due to their being heated on independent substrates).

As shown in FIGS. 1G, 1H 1I, and 1J, some embodiments may include more than one layer of the electron emissive material 14. In such embodiments, it will be appreciated that any number of layers of any thickness of the electron emissive material 14 may be disposed as desired for a particular application, thereby resulting in a desired thickness of the electron emissive material 14. It will be appreciated that, in such embodiments, including more than one layer of the electron emissive material 14 can help contribute to increasing the thickness of the electron emission layer and can also help contribute to varying the porosity through the thickness of the electron emission layer.

In various embodiments, the electron emissive material 14 may have a coefficient of thermal expansion that is equalized toward a coefficient of thermal expansion of the substrate 12. In such embodiments, expansion and contraction of the electron emissive material 14 and the substrate 12 can be equalized during thermal cycles of heating and cooling, respectively. It will be appreciated that equalization of expansion and contraction of the electron emissive material 14 and the substrate 12 during thermal cycles can help contribute to reduction of stresses induced in the electron emissive material 14 and the substrate 12, thereby helping reduce the risk of cracking of the electron emissive material 14 and/or the loss of adhesion between the substrate 12 and the electron emissive material 14. It will be appreciated that, in such cases, selection of materials for the substrate 12 and the electron emissive material 14 can result in reduction of stresses , thereby helping contribute to reducing likelihood of failure of the coating of the electron emissive material 14 or the substrate 12, and thereby helping to affect emissive performance and high temperature operation.

In some embodiments and referring additionally to FIGS. 1K and 1L, the electron emissive material 14 may define at least one pattern 22 therein. The patterns 22 may have any shape as desired for a particular application. Given by way of non-limiting example, in a columnated and shaped-beam device the size and shape of the emissive region can have a direct impact on the cross sectional shape of the beam. In some cases, beam trimming may be used to create the desired beam shape. This trimming may result in a loss of efficiency, because current is purposely removed when the beam passes through a trimming element. By controlling the emission size and shape, trimming can be lessened or eliminated entirely.

Referring additionally to FIGS. 2A-2C, in various embodiments the electron emissive material 14 may be disposed on a radially exterior surface of the substrate 12 (FIGS. 1A-1J), a radially interior surface of the substrate 12 (FIG. 2A), and/or the radially exterior surface of the substrate 12 and the radially interior surface of the substrate 12 (FIGS. 2B and 2C), as desired for a particular application. Given by way of non-limiting example, the cathode 10 shown in FIG. 2A may find application in an ion thruster and in thermionic converters where hot side of the converter is heated on the outside rather than from the inside and the collector or cold side resides inside the cathode. Given by way of further non-limiting examples, the cathode 10 shown in FIGS. 2B and 2C may find application in dual-cell converters in which the substrate 12 is heated to cause emission of electrons on both surfaces of the electron emissive material 14 at the same time.

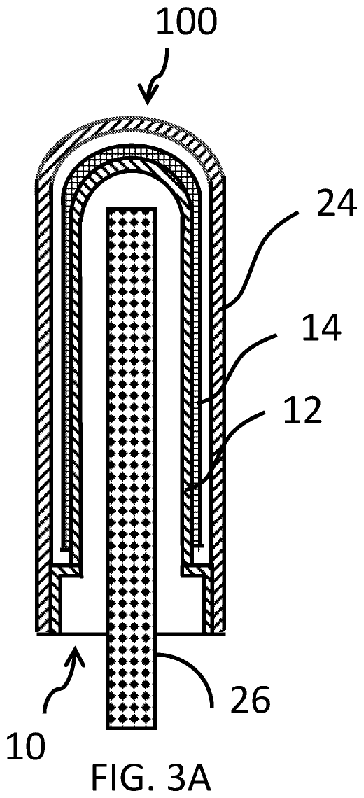

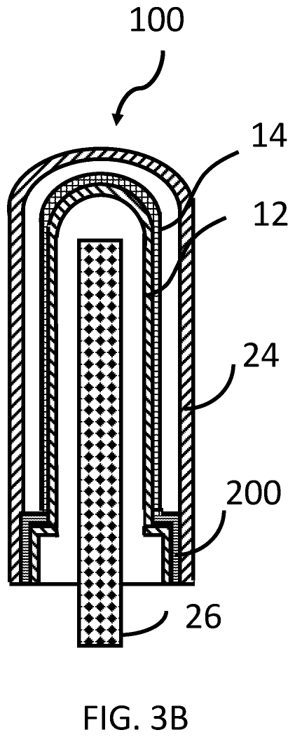

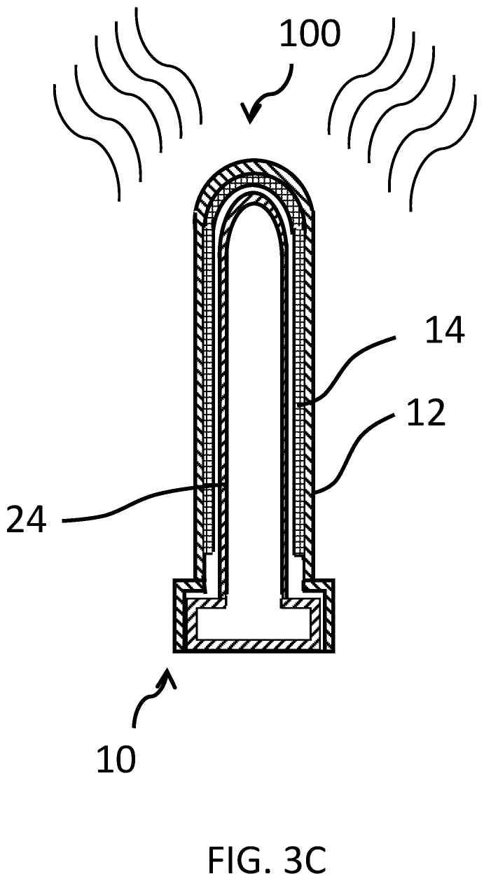

Referring additionally to FIGS. 3A-3C, in various embodiments a thermionic vacuum electronic device 100 includes the cathode 10. As discussed above, the cathode 10 includes the substrate 12 that has a predetermined shape. As also described above, the cathode 10 also includes the electron emissive material 14 that is conformally disposed on at least one portion of at least one surface of the substrate 12, and a shape of the electron emissive material 14 conforms to the predetermined shape of the substrate 12. The thermionic vacuum electronic device 100 also includes an anode 24 that is spaced apart from the cathode 10. A heat source 26 is thermally couplable to the substrate 12.

It will be appreciated that, in various embodiments, any portion of at least one electrically insulated surface of the substrate 12 without the electron emissive material 14 disposed thereon electrically isolates the cathode 10 from the anode 24.

In various embodiments, the heat source 26 may include without limitation a combustor, a flame, a heat pipe, an electric heater, an electron bombardment heater, a radiative heater, a solid material, a nuclear heat source, and/or an absorber for a concentrated light source.

In some embodiments and as shown in FIG. 3A, the substrate 12 suitably is made of an electrically insulating material. In some such embodiments and given by way of non-limiting example, the substrate 12 may be made of a ceramic material as described above. In some other such embodiments, the substrate 12 may be made of any electrically insulating material as desired, such as without limitation high temperature ceramics, silicon carbide, silicon nitride, alumina, or other non-electically-conductive high temperature ceramics.

In some other embodiments and as shown in FIG. 3B, the substrate 12 suitably is made of any suitable metal as desired. In such embodiments, an electrically insulating portion 200 (made from an electrically insulating material) is disposed on an exterior surface of the substrate 12 toward a base of the substrate 12. It will be appreciated that, in such embodiments, the electrically insulating portion 200 electrically isolates the cathode 14 from the anode 24. Given by way of non-limiting examples, the electrically insulating portion 200 may be made from high temperature ceramics, silicon carbide, silicon nitride, alumina, or other non-electically-conductive high temperature ceramics.

In some other embodiments and as shown in FIG. 3C, the electron emissive material 14 is disposed on a radially interior surface of the substrate 12 (FIG. 3C).

Other details of the cathode 10 have been described above and need not be repeated for an understanding of disclosed embodiments of the thermionic vacuum electronic device 100.

It will be appreciated the thermionic vacuum electronic device 100 may be used in various applications. For example and without limitation, the thermionic vacuum electronic device 100 of FIGS. 3A and 3B may find application in tube amplifiers, klystrons, travelling wave tubes, inductive output tubes, and the like. For example and without limitation, the thermionic vacuum electronic device 100 of FIG. 3C may find application in ion thrusters and in thermionic converters where hot side of the converter is heated on the outside rather than from the inside and the collector or cold side resides inside the cathode.

### Illustrative Fabrication Methods

Illustrative, non-limiting examples of methods of fabricating various embodiments of the cathode 10 and the thermionic vacuum electronic device 100 are set forth below.

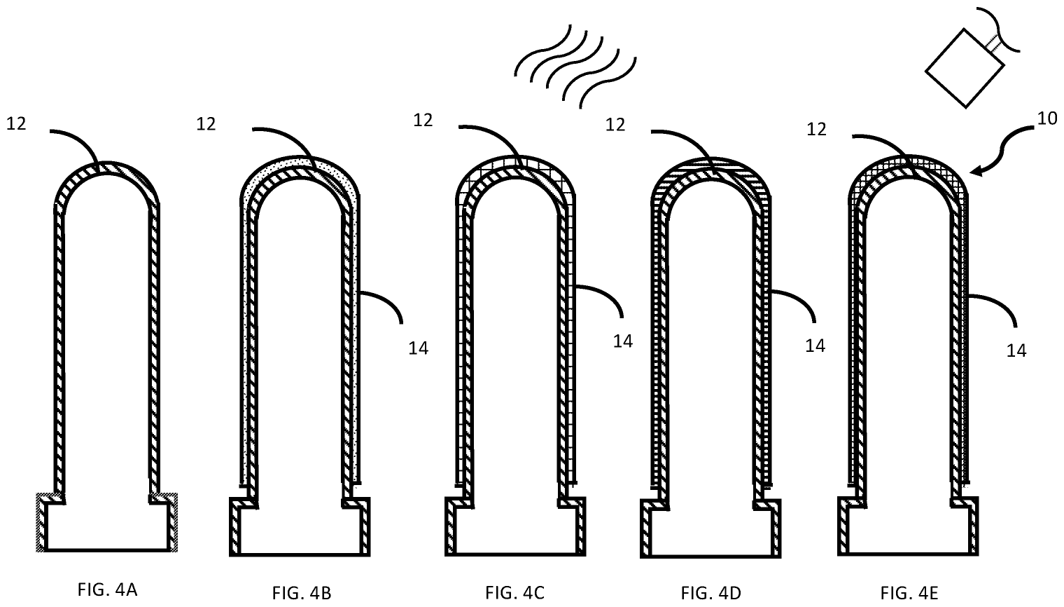

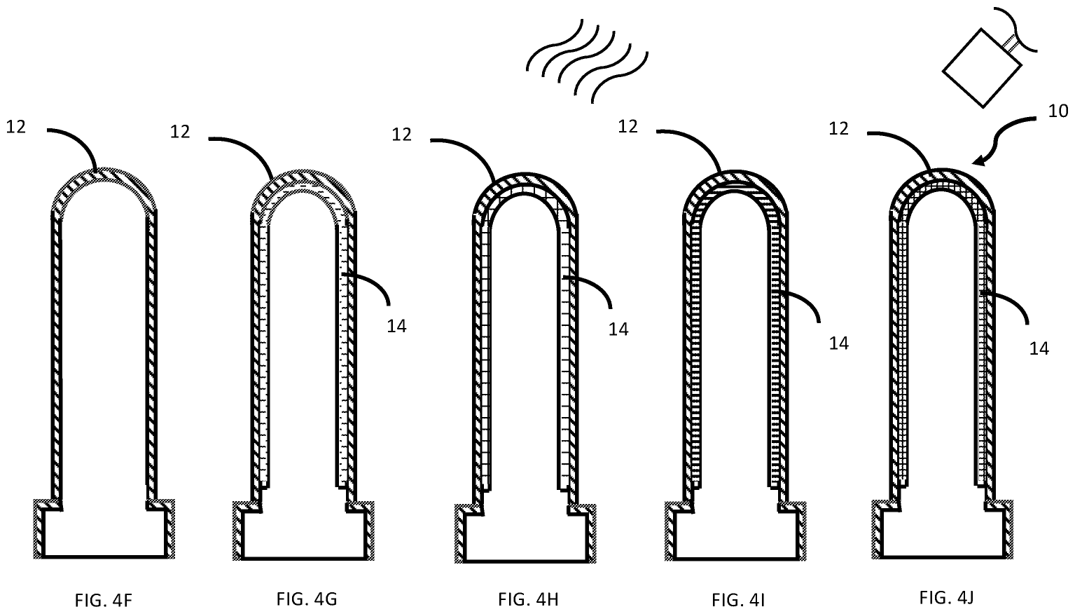

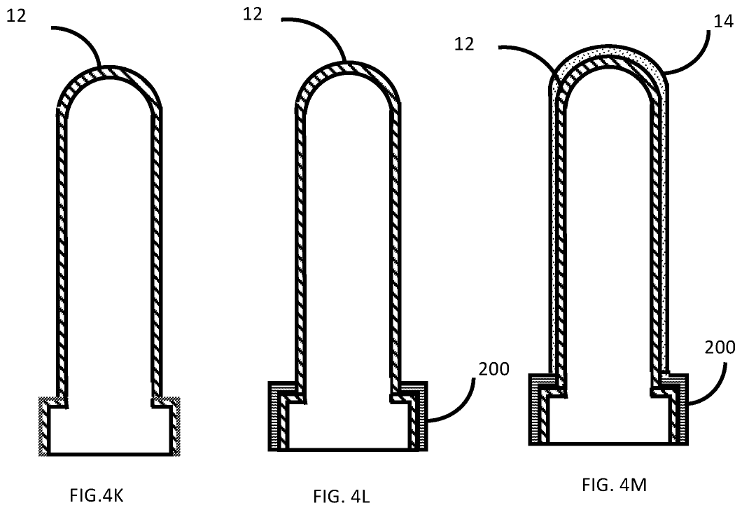

Referring additionally to FIGS. 4A-4E and 4F-4J, in various embodiments illustrative methods of fabricating cathodes 10 are provided. As shown in FIGS. 4A and 4F, the substrate 12 having a predetermined shape is provided. As shown in FIGS. 4B-4E, the electron emissive material 14 is conformally disposed on at least one portion of at least one surface of the substrate 12 such that a shape of the electron emissive material 14 conforms to the predetermined shape of the substrate 12.

It will be appreciated that, in various embodiments, any portion of an electrically insulated surface of the substrate 12 without the electron emissive material 14 disposed thereon electrically isolates the electron emissive material 14. As will be shown below, such electrical isolation isolates the cathode 10 from other electrodes of the vacuum electronic device.

In some embodiments and as shown in FIGS. 4B-4E, the electron emissive material 14 is conformally disposed on a radially exterior surface of the substrate 12. In some other embodiments and as shown in FIGS. 4G-4J, the electron emissive material 14 is conformally disposed on a radially interior surface of the substrate 12.

In various embodiments and as shown in FIGS. 4B and 4G, conformally disposing the electron emissive material 14 on at least one portion of at least one electrically insulated surface of the substrate 12 may be performed by screen printing, dip coating, spray coating, spin coating, flame spraying, plasma spraying, chemical vapor deposition, brush application, 3D metal printing, ink-jet printing, or the like. It will be appreciated that use of such processes in various embodiments can help to provide conformity of the layer of the electron emissive material 14 to the surface of the material of the substrate 12 in planar and non-planar architectures (such as, for example and without limitation, a cylinder, a polygonal cylinder, a polyhedron, a tube, a plane, a sheet, or a slab). Such processes can also help control thickness and composition of materials used in the cathode 10 and can help contribute to ease of and lowered cost of production, processing, and materials. Also, such processes may help enable size of surfaces of various disclosed cathodes 10 to be larger than that of conventionally-manufactured cathodes. Moreover, such processes may help enable geometries of disclosed cathodes 10 to be more complex than that of conventionally-manufactured cathodes.

In various embodiments and as also shown in FIGS. 4B and 4G, conformally disposing the electron emissive material on at least one portion of at least one electrically insulated surface of the substrate 12 may include conformally disposing at least one electron emissive metal slurry layer on the substrate 12. Illustrative details of suitable metal slurries have been discussed above and need not be repeated for an understanding of disclosed embodiments.

In various embodiments and as also shown in FIGS. 4B and 4G, at least one pattern may be defined in the electron emissive material 14. In some such embodiments and as mentioned above, the patterns may have any shape as desired for a particular application. Patterns of the metal slurry may be applied using screen printing or airbrushing through stencils. In some embodiments, ink jet or laser printing may be used where standard ink would be replaced by a version of the metal slurry with appropriate viscosity and particle size. In some embodiments, 3D/additive manufacturing similar to powder bed printing may be used where the metal slurry, or a liquid-free version of the metal slurry, is used in place of the powder. It will be appreciated that, in such instances, the metal slurry suitably would include typical components minus solvent and binder(s) and that sintering would occur in place via an additive manufacturing tool (such as, for example, laser, electron beam, and the like).

In some embodiments other than those entailing patterned metal slurry and as shown in FIGS. 4C and 4H, a solvent/dispersant is removed from the metal slurry. In such embodiments, removing the solvent/dispersant from the metal slurry includes heating the metal slurry at a first temperature for a desired amount of time. It will be appreciated that the first temperature and the amount of time are dependent in part upon the solvent and the thickness of the deposited metal slurry. Given by way of non-limiting examples, the first temperature and the amount of time may be between around 60° C. to around 110° C. for around 20 minutes to around 1 hour or more.

In some such embodiments and as also shown in FIGS. 4C and 4H, a binder is removed from the metal slurry. In such embodiments, removing the binder from the metal slurry includes heating the metal slurry at a second temperature, that is greater than the first temperature, for a desired amount of time. It will be appreciated that the second temperature and the amount of time are dependent in part upon the binder and the thickness of the deposited metal slurry. Given by way of non-limiting examples, the second temperature and the amount of time may be between around 120° C. to around 300° C. or higher for around 30 minutes to around 1 hour or more. It will also be appreciated that removal of the binder means that at this stage the slurry material is not well adhered to the substrate 12 (as opposed to being bound to the substrate 12).

In some such embodiments and as also shown in FIGS. 4C and 4H, the metal slurry is sintered. In such embodiments, sintering the metal slurry includes heating the metal slurry at a third temperature that is greater than the second temperature for a desired amount of time and within a desired atmosphere. It will also be appreciated that the third temperature and the amount of time are dependent in part upon the metal being applied. Given by way of non-limiting examples, the third temperature and the amount of time may be between around 1,100° C. to around 1,700° C. for around 20 minutes to around 1 hour or more. In various embodiments, sintering is performed after solvent and binder removal and before machining (discussed below). If desired, in some such embodiments sintering may be performed as a last step before machining or may be performed multiple times with thickening occurring between sintering. It will be appreciated that sintering converts the deposited layers of the metal slurry into a durable, component with targeted porosity.

It will be appreciated that, if desired, density-increasing steps may be performed for the resulting metal matrix. In some instances, it may be desirable to reduce porosity of the metal by employing additional furnace runs in controlled atmospheres or by utilizing follow-up isostatic pressing techniques or other means of densifying the matrix if it is to be used in a dispenser-style capacity.

In some embodiments and as shown in FIGS. 4D and 4I, electron emission enhancing material or materials may be included in the electron emissive material 14. In such embodiments, electron emission enhancing material or materials may be introduced into or onto the sintered metal slurry. It will be appreciated that the sintering process may be detrimental to certain emissive compounds, or the extended time necessary to process or machine (in the event machining is performed) may cause emissive compounds to take up water from the air or react with other contaminants, thereby potentially rendering them constrained in the ability (or, in some cases, unable) to perform their desired function. If additional electron emission enhancing materials are desired to be introduced into or onto the sinterted metal slurry, then incorporation of one or more of those materials may be achieved via various methods such as, but not limited to: spray application (as with barium carbonate), high temperature/controlled atmosphere impregnation (as with barium oxide), sputtering (as with osmium-ruthenium), and the like. Furthermore, if an appropriately porous cathode structure has been manufactured with an adjacent volume intended as a reservoir for electron-emissive and enhancing materials (“reservoir cathode”), it may be charged with material(s). Thus, it will be appreciated that applicability includes “oxide” cathodes (sprayed), dispenser cathodes (impregnated), M-cathodes (Os-Ru coated), reservoir cathodes (generally charged with barium oxide impregnant mixes), and the like. In such embodiments, electron emission enhancing material or materials may be introduced into or onto the sintered metal slurry by any suitable process such as, without limitation, screen printing, dip coating, spray coating, spin coating, flame spraying, plasma spraying, chemical vapor deposition, brush application, 3D metal printing, ink-jet printing, or the like, along with the host particles of either molybdeum or tungsten.

In some embodiments and as shown in FIGS. 4E and 4J, the electron emissive material may be machined. It will be appreciated that machining can help to affect the surface coating appropriate for application. It will be appreciated that uniform proximity of the cathode 10 with its extraction and/or suppression elements is generally desirable to cause a device that includes the cathode 10 to operate within desired electrical specifications. This means that it is desirable to mitigate variation of the surface of the cathode 10 across its emissive region. In various embodiments variation may be held to ±5 microns or less, so machining the surface can greatly improve the adherence to specification performance. If variation is too large, then the device that includes the cathode 10 may possibly short (especially when heated to operating temperature). Such machining of the coating may be performed by milling and/or by using a machinist's lathe and standard, appropriate tools as desired for a particular application.

In various embodiments the electron emissive material is activated. It will be appreciated that the electron emissive material may be activated via heating at a desired temperature for a desired amount of time.

Referring additionally to FIGS. 4K-4M, in some other embodiments a portion of a metal substrate 12 is electrically insulated. As shown in FIG. 4K, a metal substrate 12 is provided (as described above regarding FIG. 3B). As shown in FIG. 4L, the electrically insulating portion 200 (made from an electrically insulating material and as also described above regarding FIG. 3B) is disposed on an exterior surface of the substrate 12 toward a base of the metal substrate 12. Given by way of non-limiting examples, the electrically insulating portion 200 may be disposed via any suitable process, such as without limitation spray coating, dip coating, spin coating, brush coating followed by heating and or sintering, by screen printing, flame spraying, plasma spraying, chemical vapor deposition, 3D metal printing, ink-jet printing, or the like. In other cases the electrically insulating portion 200 may be attached to the metal substrate 12 via a brazing process well known in the vacuum device assembly art. As shown in FIG. 4L, the electron emissive material 14 is conformally disposed on at least one portion of at least one electrically conductive surface of the metal substrate 12, It will be appreciated that the electrically insulating portion 200 electrically isolates the electron emissive material 14 (for example, from other electrodes in a same device with the electron emissive material 14—such as the anode 24 (FIG. 3B) in the device 100 shown in FIG. 3B). The remainder of the processing of such embodiments of the carthode 10 continues as shown and discussed above and need not be repeated for an understanding of disclosed embodiments.

In various embodiments illustrative methods of fabricating the thermionic vacuum electronic devices 100 are provided. Referring back to FIGS. 4A-4E, 4F-4J, and 4K-4M the cathode 10 is defined. As shown in FIGS. 4A, 4F, and 4L and as described above, the substrate 12 having a predetermined shape is provided. As shown in FIGS. 4B-4E, 4G-4J, and 4M and as described above, the electron emissive material 14 is conformally disposed on at least one portion of at least one surface of the substrate 12, a shape of the cathode 10 conforming to the predetermined shape of the substrate 10. Details regarding illustrative methods of fabricating the cathodes 10 were discussed above and need not be repeated for an understanding of disclosed embodiments. In some embodiments and as shown in FIGS. 4B-4E and 4M, the electron emissive material 14 is conformally disposed on a radially exterior surface of the substrate 12. In some other embodiments and as shown in FIGS. 4G-4J, the electron emissive material 14 is conformally disposed on a radially interior surface of the substrate 12.

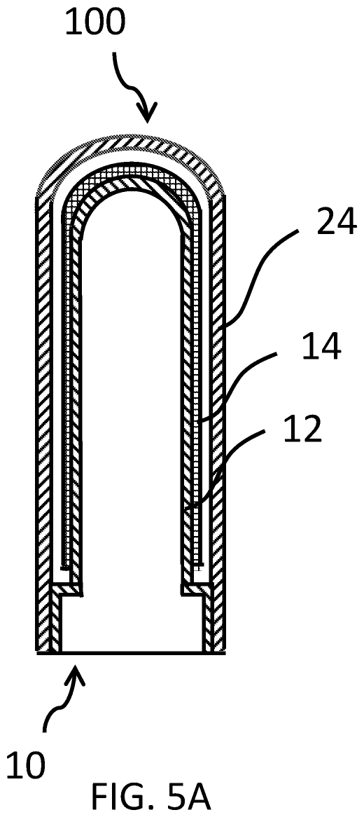

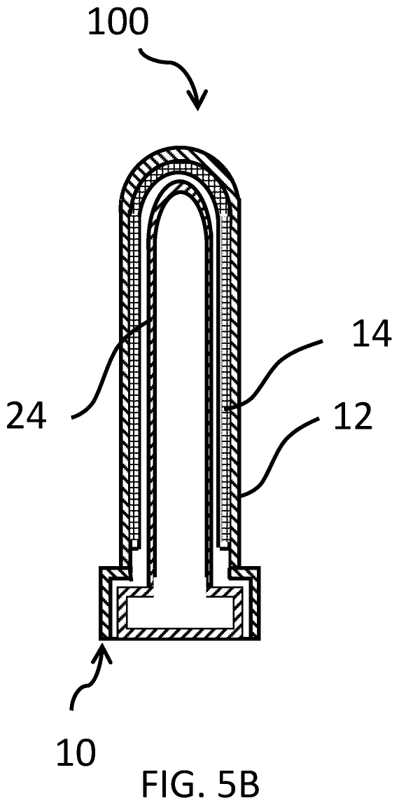

As shown in FIGS. 5A and 5B, the anode 24 that is spaced apart from the cathode 10 is defined. In various embodiments, the anode 24 may be defined by coating a metal substrate (such as without limitation copper, stainless steel, and the like) with a different metal, such as platinum, nickel, or the like.

It will be appreciated that, in various embodiments, any portion of an electrically insulated surface of the substrate 12 without the electron emissive material 14 disposed thereon electrically isolates the cathode 10 from the anode 24.

As shown in FIGS. 3A, 3B, and 3C, the heat source 26 is disposed proximate the substrate 12 such that the heat source 26 is thermally couplable to the substrate 12. As discussed above, in various embodiments the heat source 26 may include without limitation a combustor, a flame, a heat pipe, an electric heater, an electron bombardment heater, a radiative heater, a solid material, a nuclear heat source, and/or an absorber for a concentrated light source.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While a number of illustrative embodiments and aspects have been illustrated and discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

1. A cathode for a vacuum electronic device, the cathode comprising:
a substrate having a predetermined shape; and
electron emissive material disposed on at least one portion of at least one surface of the substrate, a shape of the electron emissive material conforming to the predetermined shape of the substrate.

2. The vacuum electronic device of claim 1, wherein any portion of an electrically insulated surface of the substrate without the electron emissive material disposed thereon electrically isolates the electron emissive material.

3. The vacuum electronic device of claim 1, wherein the substrate has a shape chosen from a cylinder, a polygonal cylinder, a polyhedron, a tube, a plane, a sheet, and a slab.

4. The cathode of claim 1, wherein the substrate is made of an electrically insulating material.

5. The cathode of claim 4, wherein the substrate is made of a ceramic material.

6. The cathode of claim 5, wherein the ceramic material includes at least one material chosen from aluminum oxide, silicon carbide, zirconium oxide, silicon oxide, and silicon nitride.

7. The cathode of claim 1, wherein the substrate is made from a metal.

8. The cathode of claim 7, wherein the substrate is coated on at least one surface with an electrically insulating material.

9. The cathode of claim 1, wherein the electron emissive material includes at least one metal chosen from tungsten, molybdenum, manganese, titanium, osmium, platinum, nickel, tantalum, rhenium, and niobium.

10. The cathode of claim 1, wherein the electron emissive material includes at least one electron emission enhancing material chosen from barium, calcium, thorium, strontium, barium oxide, calcium oxide, thorium oxide, strontium oxide, scandium oxide, vanadium oxide, lanthanum, lanthanum oxide, molybdenum oxide, cesium, cesium oxide, tungsten oxide, a boride of lanthanum, cerium, cerium oxide, a boride of cerium, scandium, vanadium, and carbon.

11. The cathode of claim 1, wherein the electron emissive material includes a plurality of segments that are electrically insulated from each other.

12. The cathode of claim 1, wherein the electron emissive material includes a plurality of layers.

13. The cathode of claim 1, wherein the electron emissive material has a coefficient of thermal expansion equalized toward a coefficient of thermal expansion of the substrate.

14. The cathode of claim 1, wherein the electron emissive material defines at least one pattern therein.

15. The cathode of claim 1, wherein the at least one surface of the substrate is chosen from at least one of a radially exterior surface of the substrate and a radially interior surface of the substrate.

16. A thermionic vacuum electronic device comprising:
a cathode including:
a substrate having a predetermined shape; and
electron emissive material disposed on at least one portion of at least one surface of the substrate, a shape of the electron emissive material conforming to the predetermined shape of the substrate;
an anode spaced apart from the cathode; and
a heat source thermally couplable to the substrate.

17. The vacuum electronic device of claim 16, wherein any portion of at least one electrically insulated surface of the substrate without the electron emissive material disposed thereon electrically isolates the cathode from the anode.

18. The vacuum electronic device of claim 16, wherein the heat source includes a heat source chosen from a combustor, a flame, a heat pipe, an electric heater, an electron bombardment heater, a radiative heater, a solid material, a nuclear heat source, and an absorber for a light source.

19. The vacuum electronic device of claim 16, wherein the substrate has a shape chosen from a cylinder, a polygonal cylinder, a polyhedron, a tube, a plane, a sheet, and a slab.

20. The cathode of claim 16, wherein the substrate is made of an electrically insulating material.

21. The cathode of claim 20, wherein the substrate is made of a ceramic material.

22. The cathode of claim 21, wherein the ceramic material includes at least one material chosen from aluminum oxide, silicon carbide, zirconium oxide, silicon oxide, and silicon nitride.

23. The cathode of claim 16, wherein the substrate is made from a metal.

24. The cathode of claim 23, wherein the substrate is coated on at least one surface with an electrically insulating material.

25. The cathode of claim 16, wherein the electron emissive material includes at least one metal chosen from tungsten, molybdenum, manganese, titanium, osmium, platinum, nickel, tantalum, rhenium, and niobium.

26. The cathode of claim 16, wherein the electron emissive material includes at least one electron emission enhancing material chosen from barium, calcium, thorium, strontium, barium oxide, calcium oxide, thorium oxide, strontium oxide, scandium oxide, vanadium oxide, lanthanum, lanthanum oxide, a boride of lanthanum, cerium, cerium oxide, molybdenum oxide, cesium, cesium oxide, tungsten oxide, a boride of cerium, scandium, vanadium, and carbon.

27. The cathode of claim 16, wherein the electron emissive material includes a plurality of segments that are electrically insulated from each other.

28. The cathode of claim 16, wherein the electron emissive material includes a plurality of layers.

29. The cathode of claim 16, wherein the electron emissive material has a coefficient of thermal expansion equalized toward a coefficient of thermal expansion of the substrate.

30. The cathode of claim 16, wherein the electron emissive material defines at least one pattern therein.

31. The cathode of claim 16, wherein the at least one surface of the substrate is chosen from at least one of a radially exterior surface of the substrate and a radially interior surface of the substrate.

32. A method of fabricating a cathode for a vacuum electronic device, the method comprising:
providing a substrate having a predetermined shape; and
conformally disposing electron emissive material on at least one portion of at least one surface of the substrate such that a shape of the electron emissive material conforms to the predetermined shape of the substrate.

33. The method of claim 32, wherein any portion of an electrically insulated surface of the substrate without the electron emissive material disposed thereon electrically isolates the electron emissive material.

34. The method of claim 32, wherein conformally disposing electron emissive material on at least one portion of at least one electrically insulated surface of the substrate is performed by a process chosen from screen printing, dip coating, spray coating, spin coating, flame spraying, plasma spraying, chemical vapor deposition, brush application, 3D metal printing, and ink-jet printing.

35. The method of claim 32, wherein conformally disposing electron emissive material on at least one portion of at least one electrically insulated surface of the substrate includes conformally disposing at least one electron emissive metal slurry layer on the substrate.

36. The method of claim 35, further comprising:
removing a solvent/dispersant from the metal slurry.

37. The method of claim 36, further comprising:
removing a binder from the metal slurry.

38. The method of claim 37, further comprising:
sintering the metal slurry.

39. The method of claim 38, wherein removing a solvent/dispersant from the metal slurry includes heating the metal slurry at a first temperature.

40. The method of claim 39, wherein removing a binder from the metal slurry includes heating the metal slurry at a second temperature that is greater than the first temperature.

41. The method of claim 40, wherein sintering the metal slurry includes heating the metal slurry at a third temperature that is greater than the second temperature.

42. The method of claim 38, further comprising introducing electron emission enhancing material at least one of into and onto the sintered metal slurry.

43. The method of claim 32, further comprising:
machining the electron emissive material.

44. The method of claim 32, further comprising:
activating the electron emissive material.

45. The method of claim 32, further comprising:
defining at least one pattern in the electron emissive material.

46. The method of claim 32, wherein the at least one surface of the substrate is chosen from at least one of a radially exterior surface of the substrate and a radially interior surface of the substrate.

47. A method of fabricating a thermionic vacuum electronic device, the method comprising:
defining a cathode, wherein defining the cathode includes:
providing a substrate having a predetermined shape; and
conformally disposing electron emissive material on at least one portion of at least one surface of the substrate, a shape of the electron emissive material conforming to the predetermined shape of the substrate;
defining an anode that is spaced apart from the cathode; and
disposing a heat source proximate the substrate such that the heat source is thermally couplable to the substrate.

48. The method of claim 47, wherein any portion of an electrically insulated surface of the substrate without the electron emissive material disposed thereon electrically isolates the cathode from the anode

49. The method of claim 47, wherein conformally disposing electron emissive material on at least one portion of at least one electrically insulated surface of the substrate is performed by a process chosen from screen printing, dip coating, spray coating, spin coating, flame spraying, plasma spraying, chemical vapor deposition, brush application, 3D metal printing, and ink-jet printing.

50. The method of claim 47, wherein conformally disposing electron emissive material on at least one portion of at least one electrically insulated surface of the substrate includes conformally disposing at least one electron emissive metal slurry layer on the substrate.

51. The method of claim 50, further comprising:
removing a solvent/dispersant from the metal slurry.

52. The method of claim 51, further comprising:
removing a binder from the metal slurry.

53. The method of claim 52, further comprising:
sintering the metal slurry.

54. The method of claim 53, wherein removing a solvent/dispersant from the metal slurry includes heating the metal slurry at a first temperature.

55. The method of claim 54, wherein removing a binder from the metal slurry includes heating the metal slurry at a second temperature that is greater than the first temperature.

56. The method of claim 55, wherein sintering the metal slurry includes heating the metal slurry at a third temperature that is greater than the second temperature.

57. The method of claim 53, further comprising introducing electron emission enhancing material at least one of into and onto the sintered metal slurry.

58. The method of claim 47, further comprising:
machining the electron emissive material.

59. The method of claim 47, further comprising:
activating the electron emissive material.

60. The method of claim 47, further comprising:
defining at least one pattern in the electron emissive material.

61. The method of claim 47, wherein the at least one surface of the substrate is chosen from at least one of a radially exterior surface of the substrate and a radially interior surface of the substrate.
